(19) United States
(12) Patent Application Publication
(10) Pub. No.: US 2017/0315313 A1
(43) Pub. Date: Nov. 2, 2017

(54) Transistor Outline (TO) Can Optical Transceiver

(71) Applicant: Futurewei Technologies, Inc., Plano, TX (US)

(72) Inventor: Ning Cheng, Basking Ridge, NJ (US)

(21) Appl. No.: 15/497,427

(22) Filed: Apr. 26, 2017

Related U.S. Application Data
(60) Provisional application No. 62/328,696, filed on Apr. 28, 2016.

(51) Int. Cl. G02B 6/42; H04B 10/40

(52) U.S. Cl. CPC G02B 6/4263; H04B 10/40; G02B 6/4277; G02B 6/4215; G02B 6/4245; G02B 6/4246

(57) ABSTRACT

An optical transceiver comprises a transmitter and a receiver housed in a transistor outline (TO) can. The receiver comprises a first submount comprising at least one waveguide, a photodiode coupled to the first submount and the at least one waveguide, and a transimpedance amplifier (TIA) coupled to the first submount and the at least one waveguide, wherein the at least one waveguide couples the photodiode to the TIA, wherein the at least one waveguide is positioned on the first submount in between the photodiode and the TIA.

### CROSS-REFERENCE TO RELATED APPLICATIONS

The present application claims benefit of U.S. Provisional Patent Application No. 62/328,696 filed Apr. 28, 2016 by Ning Cheng and entitled “Transistor Outline (TO) Can Optical Transceiver,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

An optical transceiver is a device that is capable of both transmitting and receiving optical signals. Optical transceivers have many applications, including use in passive optical networks (PONs). Optical transceivers may comprise both optical components and electrical components. The components may be integrated together in a single integrated chip. Multiple such integrated chips may make up a system in package (SIP).

In optical-to-electrical and electrical-to-optical modules used in the various communications fields, a problem is the electrical interconnection of the various components and the shielding of the various components to prevent radiation, (e.g., electromagnetic interference (EMI)) into or out of the module. Providing this efficient interconnection and shielding requires very precise assembly procedures.

### SUMMARY

In one embodiment, the disclosure includes an optical transceiver comprising a transistor outline (TO)-can and a receiver housed inside the TO-can. The receiver comprises a first submount comprising at least one first waveguide, a photodiode coupled to the at least one first waveguide, and a transimpedance amplifier (TIA) coupled to the first submount and the at least one first waveguide. The at least one first waveguide couples the photodiode to the TIA, and the at least one first waveguide is positioned on the first submount in between the photodiode and the TIA. In some embodiments, the photodiode and the TIA are flip-chip bonded to the first submount. In some embodiments, a contact point on the photodiode is coupled to a first contact point on the at least one first waveguide, and a contact point on the TIA is coupled to a second contact point on the at least one first waveguide. In some embodiments, the optical transceiver further comprises a transmitter housed in a TO-can, wherein the transmitter comprises a second submount comprising at least one second waveguide, a bonding wire, and a laser diode coupled to the at least one second waveguide, wherein the at least one second waveguide couples the bonding wire to the laser diode. In some embodiments, the laser diode is flip-chip bonded to the second submount. In some embodiments, the TO-can comprises a TO-header and a TO-cap coupled to the TO-header, and/or wherein the second submount passes through the TO-header of the TO-can. In some embodiments, the first submount comprises a second waveguide, wherein the second waveguide couples to a bonding wire, and wherein the bonding wire couples to an input/output (I/O) pin of the optical transceiver. In some embodiments, a ground plane is formed on the first submount around the at least one first waveguide and an isolation layer surrounding the at least one first waveguide. In some embodiments, the optical transceiver further comprises a wavelength-division multiplexing (WDM) filter interposed between the receiver and the transmitter, and a lens transmitting light between an interior and an exterior of the optical transceiver.

In one embodiment, the disclosure includes an optical transceiver comprising a receiver and a transmitter. The receiver comprises a TIA, a photodiode, and a first submount comprising at least one first waveguide, wherein the at least one first waveguide is configured to couple the TIA and the photodiode. The transmitter comprises a laser diode, an I/O pin, and a second submount comprising at least one second waveguide, wherein the at least one second waveguide couples to a bonding wire, and wherein the bonding wire couples to the I/O pin. In some embodiments, the optical transceiver further comprises a TO-can housing the transmitter and the receiver, and/or a TO-header, wherein the transmitter and the receiver are positioned on the TO-header. In some embodiments, the photodiode and the TIA are flip-chip bonded to the first submount, wherein a contact point on the photodiode is bonded to a first contact point on the at least one first waveguide, and wherein a contact point on the TIA is bonded to a second contact point on the at least one first waveguide. In some embodiments, the laser diode is flip-chip bonded to the second submount, wherein a contact point on the laser diode is bonded to a contact point on the at least one second waveguide. In some embodiments, ground plane is formed on the first submount around the at least one first waveguide and an isolation layer surrounding the at least one first waveguide. In some embodiments, a ground plane is formed on the second submount around the at least one second waveguide and an isolation layer surrounding the at least one second waveguide.

In one embodiment, the disclosure includes a method implemented in a TO-can, the method comprising receiving, by a lens, a first light from outside the TO-can, filtering, by a filter, the first light, converting, by a back-illuminated photodiode, the first light into a current, and passing, by the back-illuminated photodiode via a waveguide, the current to a TIA, wherein the waveguide is positioned on a first submount, and wherein the first submount is positioned in between the back-illuminated photodiode and a TO-header of the TO-can. In some embodiments, the method further comprising converting, by the TIA, the current to a voltage, and communicating the voltage to an I/O pin via a bonding wire. In some embodiments, the method further includes receiving, by a laser diode and via a second waveguide, instructions to emit a second light, emitting, by the laser diode, the second light, filtering, by the filter, the second light, and directing, by the lens, the second light outside the TO-can.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a PON according to an embodiment of the disclosure.

FIG. 2 is a schematic diagram of a portion of a bi-directional optical sub-assembly (BOSA) implemented as an optical transceiver in an ONU or OLT according to an embodiment of the disclosure.

FIG. 3 is a schematic diagram illustrating a portion of the receiver of the BOSA of FIG. 2.

FIG. 4 is a top view of the portion of the receiver in FIG. 3.

FIG. 5 is a schematic diagram of a portion of a BOSA implemented as an optical transceiver in an ONU or OLT according to another embodiment of the disclosure.

FIG. 6 is a schematic diagram illustration a portion of the transmitter of the BOSA in FIG. 5.

FIG. 7 is a top view of the portion of the transmitter in FIG. 6.

FIG. 8 is a schematic diagram of a portion of a BOSA implemented as an optical transceiver in an ONU or OLT according to yet another embodiment of the disclosure.

FIG. 9 is a flowchart illustrating a method of receiving a light according to an embodiment of the disclosure.

FIG. 10 is a schematic diagram of a device according to an embodiment of the disclosure.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

A transceiver in an optical line terminal (OLT) or an optical network unit (ONU) of a PON typically includes a BOSA. A traditional BOSA uses two TO cans in which one TO-can houses the transmitter and a separate TO-can houses the receiver. In this type of BOSA, the transmitted signal and the received signal do not experience crosstalk between the two signals because the transmitted electrical signal and the received electrical signal are contained in two separate TO-cans. However, the use of two separate TO-cans in a BOSA requires a complicated packaging structure and a high cost.

To solve the cost issue of using two separate TO-cans, a single TO-can BOSA has been introduced in which the transmitter and receiver are housed within a single TO-can. The single TO-can BOSA includes a transmitter and a receiver, both of which are positioned on a TO-header. The transmitter includes a monitor photodiode (MPD) and a laser diode, both of which are connected to respective I/O pins using separate bonding wires. The receiver includes a photodiode and a TIA. The photodiode and the TIA are each connected to different I/O pins using separate bonding wires. The bonding wires typically extend from a contact point at a top surface of an I/O pin to a contact point at a top surface of the MPD, laser diode, photodiode, or TIA. The photodiode and the TIA are also connected to one another via another bonding wire. This bonding wire also extends from a contact point at a top surface of the photodiode to a contact point at a top surface of the TIA.

As the received optical signal power could be very low, the bonding wire in the receiver connecting the photodiode to the TIA experiences a very low current, such as less than 10 microamps (μA). This makes the bonding wire connecting the photodiode to the TIA susceptible to crosstalk and interception of unwanted electromagnetic interference (EMI). The bonding wire in the transmitter, connecting the laser diode to an I/O pin, experiences a relatively high current, such as between 30 and 50 milliamps (mAs). This high modulation current is used by the laser diode to generate an optical signal. Thus, the bonding wire carrying this high modulation current is very susceptible to emitting EMI. In addition, the length of the bonding wires that extends from the top surface of the laser diode, I/O pin, photodiode, and TIA in the single TO-can BOSA enables the bonding wires to act as antennas that are even more susceptible to emitting and receiving EMI. The low current signal travelling through the bonding wire that connects the photodiode to the TIA enables that bonding wire in the receiver to act as an antenna that picks up EMI from the bonding wire that connects the laser diode to the I/O pin and carries the high signal-level electrical current in the transmitter. Therefore, the use of bonding wires to connect the various component parts in the single-TO-can BOSA results in crosstalk being experienced between the transmitter and the receiver.

Disclosed herein are embodiments of a single-TO-can BOSA in which the receiver reduces or eliminates crosstalk from the transmitter. For example, the single-TO-can BOSA comprises a transmitter, receiver, and a TO-header. In an embodiment, the receiver comprises a first submount positioned on the TO-header. The at least one first electrical waveguide is integrated into the first submount and couples the photodiode to the TIA. In an embodiment, the laser diode, photodiode, and/or TIA are flip-chip bonded to the first submount in a single-TO-can BOSA using waveguides formed on the first submount. In an embodiment, the waveguides are deposited onto the first submount. The photodiode is flip-chip bonded to a first contact point on the first waveguide of the first submount. The term flip-chip bonding refers to flipping a component of the single-TO-can BOSA upside down so that a contact point that is typically on the top surface of the component is now flipped to become the bottom surface of the component, and the contact point of the component abuts, or is substantially adjacent to, a contact point of a waveguide disposed on the submount. The TIA can likewise be flip-chip bonded to a second contact point on the first waveguide of the first submount, wherein the first waveguide electrically couples the components. In an embodiment, the use of the first waveguide to couple the photodiode to the TIA, instead of coupling via a bonding wire, reduces the EMI experienced by the receiver of the single-TO-can BOSA.

In an embodiment, the transmitter comprises a second submount positioned on the TO-header. At least a second waveguide is integrated into the second submount and couples the laser diode of the transmitter to a bonding wire and an I/O pin. In an embodiment, the second waveguide comprises a third contact point configured to couple to a contact point on the laser diode. The laser diode can be flip-chip bonded to the third contact point on the second waveguide of the second submount. The bonding wire may be used to connect a fourth contact point on the second waveguide to the I/O pin. This bonding wire may be shorter than the bonding wire used to connect the laser diode to an I/O pin in a traditional BOSA. Therefore, the use of the second waveguide and the shorter bonding wire further reduces the electromagnetic radiation (EMR) emitted by the transmitter of the single-TO-can BOSA.

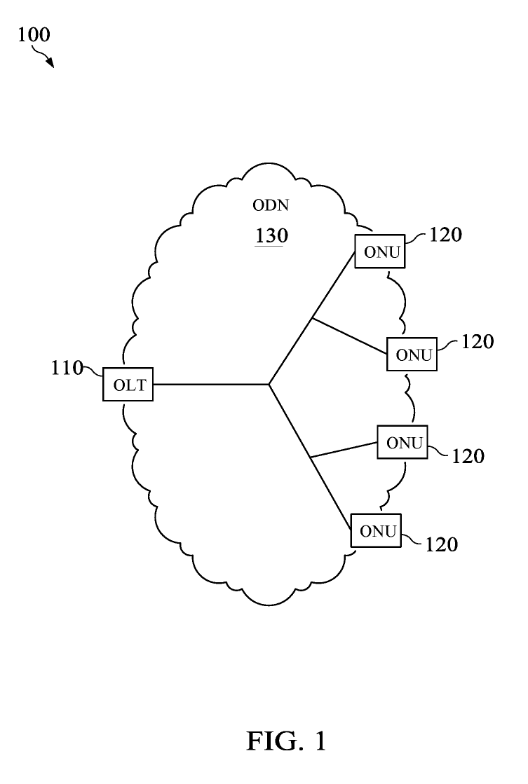

FIG. 1 is a schematic diagram of a PON 100. The PON 100 comprises an OLT 110, a plurality of ONUs 120, and an optical distribution network (ODN) 130 that couples the OLT 110 to the ONUs 120. The PON 100 is suitable for implementing the disclosed embodiments. The PON 100 is a communications network that may not require active components to distribute data between the OLT 110 and the ONUs 120. Instead, the PON 100 may use passive optical components in the ODN 130 to distribute data between the OLT 110 and the ONUs 120.

The OLT 110 communicates with the ONUs 120 and another network. Specifically, the OLT 110 is an intermediary between the other network and the ONUs 120. For instance, the OLT 110 forwards data received from the other network to the ONUs 120 and forwards data received from the ONUs 120 to the other network. The OLT 110 comprises a transmitter and a receiver. When the other network uses a network protocol that is different from the protocol used in the PON 100, the OLT 110 comprises a converter that converts the network protocol to the PON protocol and vice versa. The OLT 110 is typically located at a central location such as a central office (CO), but it may also be located at other suitable locations.

The ODN 130 is a data distribution system that comprises optical fiber cables, couplers, splitters, distributors, and other suitable components. The components include passive optical components that do not require power to distribute signals between the OLT 110 and the ONUs 120. The components may also include active components such as optical amplifiers that do require power. The ODN 130 extends from the OLT 110 to the ONUs 120 in a branching configuration as shown, but the ODN 130 may be configured in any other suitable point-to-multipoint (P2MP) configuration.

The ONUs 120 communicate with the OLT 110 and a customer, and act as an intermediary between the OLT 110 and the customer. For instance, the ONUs 120 forward data from the OLT 110 to the customer and forward data from the customer to the OLT 110. The ONUs 120 comprise an optical transmitter that converts electrical signals into optical signals and transmits the optical signals to the OLT 110, and the ONUs 120 comprise an optical receiver that receives optical signals from the OLT 110 and converts the optical signals into electrical signals. The ONUs 120 further comprise a second transmitter that transmits the electrical signals to the customer and a second receiver that receives electrical signals from the customer. ONUs 120 and optical network terminals (ONTs) are similar, and the terms may be used interchangeably. The ONUs 120 are typically located at distributed locations such as customer premises, but they may also be located at other suitable locations.

Disclosed herein are embodiments for improved optical transceivers in the ONUs 120 and/or in the OLT 110, with an optical transceiver comprising a single TO-can BOSA. The receiver according to any embodiment comprises a first submount positioned in between a TO-header and the photodiode and the TIA. The first submount comprises at least one first waveguide. The photodiode is flip-chip bonded to the first submount via a waveguide or waveguides. The TIA likewise can be flip-chip bonded to the first submount via a waveguide or waveguides. The single TO-can BOSA conserves cost, and the use of the waveguides on the first submount reduce or eliminate crosstalk.

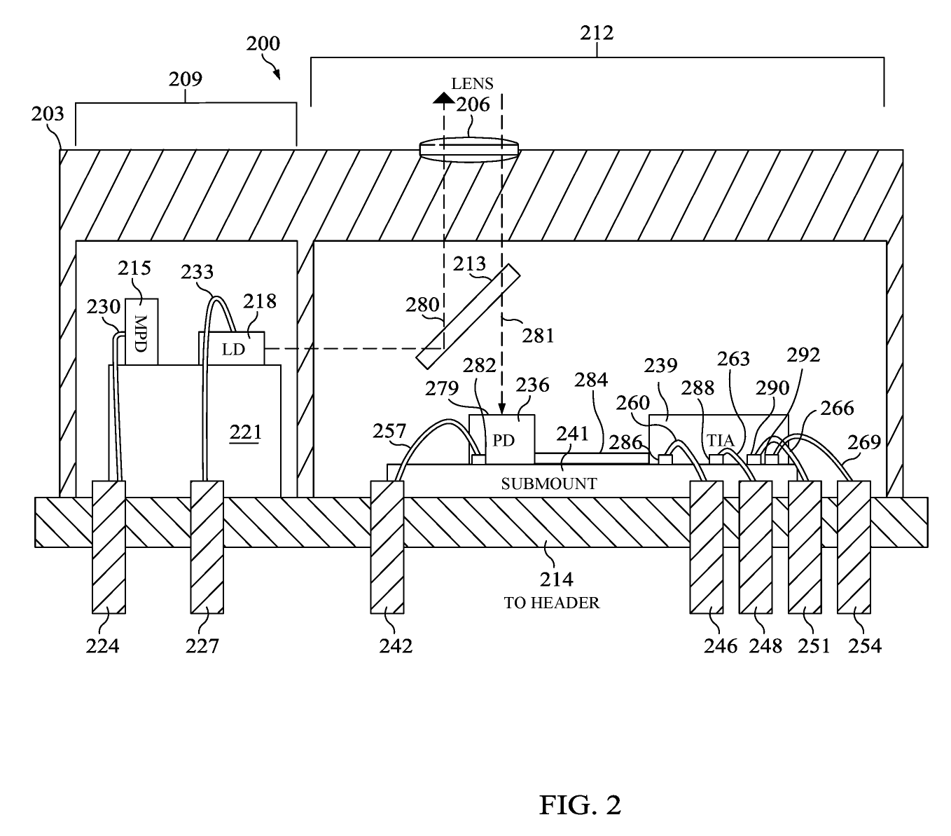

FIG. 2 is a schematic diagram of a portion of a BOSA 200 implemented as an optical transceiver in an ONU 120 or OLT 110 according to an embodiment of the disclosure. The single TO-can BOSA 200 comprises a TO-cap 203, lens 206, a transmitter 209, a receiver 212, an optical filter (filter) 213, and a TO-header 214. The BOSA 200 may be housed in a single TO-package or TO-can.

The transmitter 209 in the embodiment shown comprises a monitor photodiode (MPD) 215, a laser diode 218 (LD), a intermediary layer 221, and I/O pins 224 and 227. As should be appreciated, any number of I/O pins 224 and 227 may be included in the transmitter 209. The intermediary layer 221 may be a substrate or a support block, such as a metal block for example. The MPD 215 is coupled to the I/O pin 224 via a bonding wire 230. The laser diode 218 is coupled to the I/O pin 227 via a bonding wire 233. The MPD 215 receives light (not shown) from the laser diode 218 and converts that light to electrical signals to monitor and ensure that the laser diode 218 emits light with desired characteristics, such as a desired power. The laser diode 218 is a distributed feedback (DFB) laser diode or any laser diode suitable for emitting light with the desired characteristics. The I/O pins 224 and 227 may be coupled to an external laser diode driver for controlling the MPD 215 and the laser diode 218. For instance, the laser diode driver may instruct the laser diode 218 to emit light with the desired characteristics. The laser diode driver may be located on, for instance, a printed circuit board (PCB) coupled to the BOSA 200.

The filter 213 is interposed between the lens 206 and the transmitter 209 and the receiver 212 in some embodiments. The filter 213 is communicatively coupled to both the transmitter 209 and the receiver 212. The filter 213 is a WDM filter or other suitable filter. The filter 213 can affect outgoing light generated by the transmitter 209 and can direct the outgoing light to the lens 206. The light emitted from the laser diode 218 is reflected by the filter 213, wherein the filter 213 operates to combine or separate the optical signals as needed. The outgoing optical signal that is passed through, or reflected through, the filter 213 then travels through the lens 206.

The receiver 212 comprises a photodiode 236 (PD), a TIA 239, a first submount 241, I/O pins 242, 246, 248, 251, and 254, and bonding wires 257, 260, 263, 266, and 269. The filter 213 can affect incoming light that enters via the lens 206 and can direct the incoming light to the photodiode 236. As should be appreciated, any number of I/O pins 242, 246, 248, 251, and 254 may be included in the receiver 212. As shown in FIG. 2, the photodiode 236 and the TIA 239 are flip-chip bonded to the first submount 241. For example, the photodiode 236 is flipped upside down such that a contact point on the photodiode 236 that is typically on the top surface of the photodiode 236 is now flipped to be on the bottom surface of the photodiode 236. In an embodiment, the photodiode 236 may comprise an avalanche photodiode (APD), a p-i-n photodiode, or another suitable photodiode, and comprises indium gallium arsenide (AlGaAs) or another suitable material. In an embodiment, the photodiode 236 may be a back-illuminated photodiode where the incoming light signal passes through the substrate of the photodiode before being absorbed in the photosensitive area of the photodiode. For example, the back surface of the photodiode comprises the substrate of the photodiode, facing the lens 206. The TIA 239 is also flipped upside down such that a contact point on the TIA 239 that is typically on the top surface of the TIA 239 is now flipped to be on the bottom surface of the TIA 239. The TIA 239 comprises silicon (Si) or another suitable material.

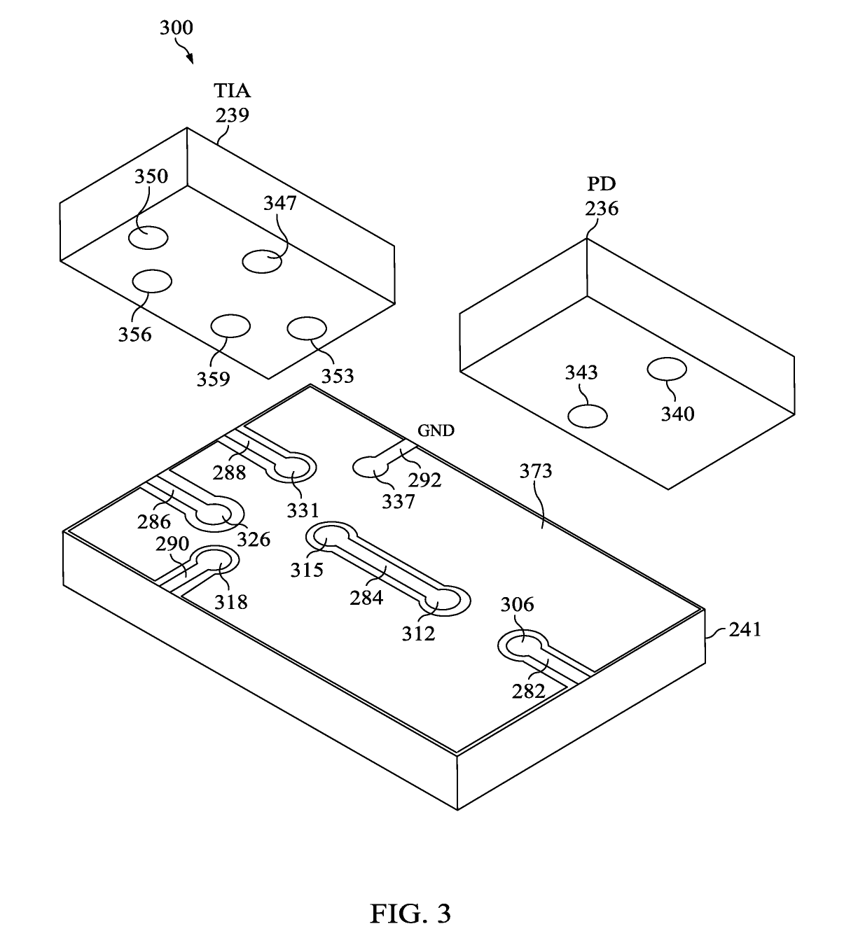

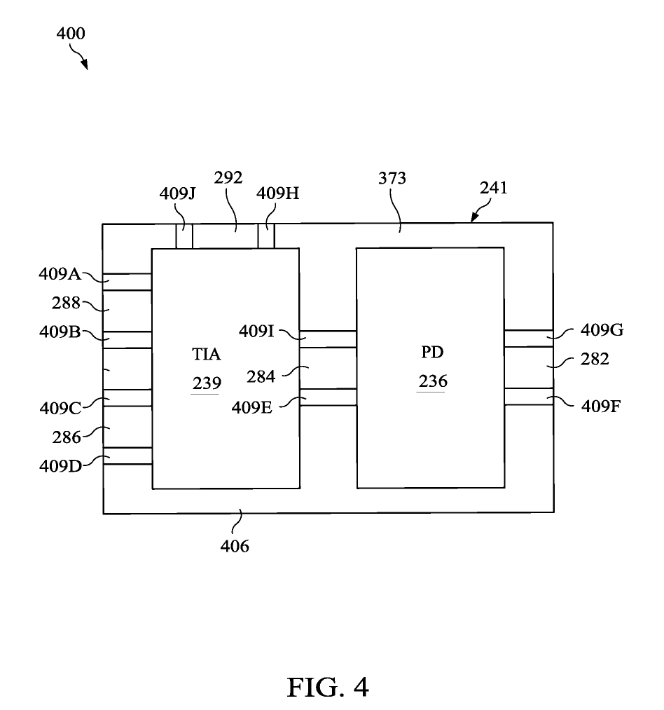

The photodiode 236 and the TIA 239 are flip-chip bonded to the first submount 241 via first waveguides 282, 284, 286, 288, 290, and 292. In an embodiment, first submount 241 comprises first waveguides 282, 284, 286, 288, 290, and 292 such that first waveguides 282, 284, 286, 288, 290, and 292 are formed onto or integrated onto the first submount 241. In an embodiment, first waveguides 282, 284, 286, 288, 290, and 292 are deposited onto the first submount 241. In an embodiment, a surface of the first submount 241 comprises a ground plane, and a pattern is etched (or otherwise formed) into the ground plane such that the first waveguides 282, 284, 286, 288, 290, and 292 are disposed directly on the first submount 241 and do not contact the ground plane, as is further described below in FIGS. 3-4. The first submount 241 is positioned on the TO-header 214 and comprises a dielectric material, such as aluminum nitride (AlN) or another suitable material.

The first waveguides 282, 284, 286, 288, 290, and 292 are coplanar with one another in that they all are disposed on substantially the same plane of the first submount 241. In an embodiment, the photodiode 236 is flipped upside down so that a contact point on the photodiode 236 is coupled directly to a contact point of a waveguide 284 on the first submount 241. Similarly, the TIA 239 is also flipped upside down so that a contact point on the TIA 239 is coupled directly to another contact point of the waveguide 284 on the first submount 241. In this way, the use of the waveguide 284 on the first submount 241 eliminates the need to use a bonding wire to connect the photodiode 236 to the TIA 239. In an embodiment, first waveguides 282, 284, 286, 288, 290, and 292 are configured to carry high frequency signals.

In an embodiment, one or more bonding wires 257, 260, 263, 266, and 269 are used to couple the first waveguides 282, 286, 288, 290, and 292 to I/O pins 242, 246, 248, 251, and 254. For example, first waveguide 282 is disposed on the first submount 241 and connects the photodiode 236 to bonding wire 257 that connects to the I/O pin 242. I/O pin 242 may connect to a power supply (not shown). The power supply may be an external power supplied to provide a bias voltage to the photodiode 236. For example, first waveguide 286 is disposed on the first submount 241 and connects the TIA 239 to bonding wire 260 that connects to the I/O pin 246. In an embodiment, first waveguide 288 is disposed on the first submount 241 and connects the TIA 239 to bonding wire 263 that connects to the I/O pin 248. The I/O pins 246 and 248 may be coupled to an external circuit for further signal processing, which may comprise a limiting amplifier and a clock and data recovery (CDR) circuit in some embodiments. In an embodiment, first waveguide 290 is disposed on the first submount 241 and connects the TIA 239 to bonding wire 266 that connects to the I/O pin 251. The I/O pin 251 may connect to a power supply (not shown). The power supply may be an external power supplied to provide a voltage supply to the TIA 239. In an embodiment, first waveguide 292 is disposed on the first submount 241 and connects the TIA 239 to a bonding wire 269 that connects to I/O pin 254. I/O pin 254 may connect to a ground or to the ground layer disposed on the first submount 241. In an embodiment, the first waveguide 292 and/or the bonding wire 269 may not be needed and the contact point on the TIA 239 may connect directly to a ground layer disposed on the first submount 241.

In a first operation, the external LD driver mentioned above directs the laser diode 218 to emit a first light 280 with desired characteristics. The laser diode 218 emits the first light 280 towards the filter 213. The filter 213 directs the first light to the lens 206 and towards an external device, which may be an optical fiber. In a second operation, the BOSA 200 receives a second light 281 from the external device. The lens 206 directs the second light 281 towards the filter 213. The filter 213 passes the second light 281 to a back surface of the photodiode 236. For example, in the back-illuminated photodiode 236, the second light 281 enters from the substrate surface 279 of the photodiode 236. The photodiode 236 receives the second light 281 and converts that second light 281 to electrical signals or a current for further signal processing. The photodiode 236 then passes the current to the TIA 239 via first waveguide 284. The TIA 239 receives the electrical signals from the photodiode 236, which are in the form of electrical currents, converts the current to voltages, and passes the voltages to an external device for further signal processing via first waveguides 288 and 290.

FIG. 3 is a schematic diagram illustrating a portion 300 of the receiver 212 of BOSA 200 according to an embodiment of the disclosure. The portion 300 of the receiver 212 comprises the first submount 241, the photodiode 236 (PD), and the TIA 239. The first submount 241 comprises a ground plane 373 and first waveguides 282, 284, 286, 288, 290, and 292. In an embodiment, the ground plane 373 is a plane that is parallel to the first submount 241 and disposed on top of or coupled to the first submount 241. The ground plane 373 may be an electrically conductive metal layer, such as gold (Au). In an embodiment, the ground plane 373 is deposited or laminated onto the first submount 241. In an embodiment, the ground plane 373 covers most, if not all, of the surface of the first submount 241.

In an embodiment, a pattern for the first waveguides 282, 284, 286, 288, 290, and 292 and an isolation layer surrounding the first waveguides 282, 284, 286, 288, 290, and 292 may be etched out from the ground plane 373. For example, the ground plane 373 is etched out at the locations where the first waveguides 282, 284, 286, 288, 290, and 292 are to be positioned. This prevents the first waveguides 282, 284, 286, 288, 290, and 292 from contacting the ground plane 373 in a vertical direction because the first waveguides 282, 284, 286, 288, 290, and 292 only contact the first submount 241. In an embodiment, the ground plane 373 is etched out at the positions where the isolation layers shown in FIG. 4 surrounding waveguides 282, 284, 286, 288, and 290 are to be positioned. The isolation layer in some embodiments comprises an additional layer that is etched from around each of the waveguides 282, 284, 286, 288, and 290. In an embodiment, the isolation layer is a gap between one of the first waveguides 282, 284, 286, 288, and 290 and the ground plane 373. In this way, first waveguides 282, 284, 286, 288, and 290 do not contact the ground plane 373 in the horizontal direction, either.

As shown in FIG. 3, waveguide 292 is not surrounded by an isolation layer. This is because contact point 353 on the TIA 239 is grounded by contact point 337 on waveguide 292. Therefore, the embodiment shown in FIG. 3 illustrates how the TIA is grounded by contacting the first waveguide 292, which directly contacts (or is part of) the ground plane 373. In an embodiment, waveguide 292 is not needed, and contact point 353 may directly contact the ground plane 373 to ground the TIA 239.

In an embodiment, the first waveguides 282, 284, 286, 288, 290, and 292 may comprise metal, such as copper (Cu), Au, or any other suitable electrically conductive material. The first waveguides 282, 284, 286, 288, 290, and 292 comprise contact points corresponding to the contact points on the photodiode 236 and the TIA 239. The contact points on the photodiode 236 and the TIA 239 may be similar to the rest of the other contact points on the first waveguides 282, 284, 286, 288, 290, and 292 or the contact points on the photodiode 236 and the TIA 239 may have different shapes or sizes to facilitate connections to the first waveguides 282, 284, 286, 288, 290, and 292.

In an embodiment, photodiode 236 has two contact points 340 and 343 that face the contact points of waveguides 282 and 284 on the first submount 241. In an embodiment, the photodiode 236 is flip-chip bonded to the first submount 241 such that the contact points 340 and 343 directly couple to the contact points on the first waveguides 282 and 284. As shown in FIG. 3, first waveguide 282 comprises a contact point 306 that is configured to couple to contact point 340 on the photodiode 236. First waveguide 284 comprises a first contact point 312 configured to couple to the contact point 343 on the photodiode 236. In an embodiment, first waveguide 282 is configured to provide a bias voltage to the photodiode 236.

In an embodiment, TIA 239 has five contact points 347, 350, 353, 356, and 359 that configured to couple to the contact points of first waveguides 284, 286, 288, 290, and 292 on the first submount 241. In an embodiment, the TIA 239 is flip-chip bonded to the first submount 241 such that the contact points 347, 350, 353, 356, and 359 directly couple to the contact points on the first waveguides 284, 286, 288, 290, and 292. First waveguide 284 also comprises a second contact point 315 configured to couple to contact point 347 on TIA 239. Therefore, first waveguide 284 connects the photodiode 236 to the TIA 239. First waveguide 284 may also be configured to receive a current from the photodiode 236 and transmit the current to the TIA 239 such that TIA 239 converts the current to a voltage. First waveguide 290 comprises a contact point 318 configured to couple to contact point 350 on the TIA 239. In an embodiment, first waveguide 290 is configured to provide a voltage supply to TIA 239. First waveguide 286 comprises a contact point 326 configured to couple to contact point 356 on the TIA 239. In an embodiment, first waveguide 286 connects to an I/O pin 246 on the BOSA 200 to a differential voltage output to the external circuit. First waveguide 288 comprises a contact point 331 configured to couple to contact point 359 on the TIA 239. In an embodiment, first waveguide 288 connects to an I/O pin 248 on the BOSA 200 to provide a differential voltage output to the external circuit. The differential output may be more than a few millivolts (mV) and may therefore be less susceptible to crosstalk. First waveguide 292 comprises a contact point 337 configured to couple to contact point 353 that grounds the TIA 239 to the submount. In an embodiment, first waveguide 292 is not necessary and contact point 353 is configured to directly ground the TIA 239 to the first submount 241, such as the ground plane 373. In an embodiment, first waveguides 286, 288, 290, and 292 may be wire bonded to the I/O pins using bonding wires.

The TIA 239 and the photodiode 236 may be bonded to the first submount 241 by soldering the contact points of the first waveguides 282, 284, 286, 288, 290, and 292 with the contact points on the TIA 239 and photodiode 236, or another suitable means. The TIA 239, the photodiode 236, and the first submount 241 may comprise bonding pads to implement bonding. In an embodiment, the contact points on the first waveguides 282, 284, 286, 288, 290, and 292 and the contact points on the photodiode 236 and the TIA 239 are solder bumps that may comprise a metal, such as Cu, Au, or another suitable material. The solder bumps on the photodiode 236 and the TIA 239 may be deposited on the photodiode 236 and the TIA 239.

The use of the first waveguide 284 to connect to the photodiode 236 and the TIA 239 obviates the need to use a bonding wire to connect the photodiode 236 and the TIA 239. Since the receiver 212 in BOSA 200 does not use a bonding wire to carry a low current from the photodiode 236 to the TIA 239, there is nothing in the receiver 212 to act as an EMI sensitive antenna that easily picks up EMI. In addition, the first waveguide 284 is integrated into the first submount 241 such the ground plane 373 does not contact first waveguide 284. Therefore, the first waveguide 284 is slightly shielded from EMI due to the substantially surrounding ground plane 373. Therefore, the receiver 212 will experience less EMI from the transmitter 209, and crosstalk is effectively reduced in BOSA 200.

FIG. 4 is a top view 400 of the portion 300 of the receiver 212 of BOSA 200 according to an embodiment of the disclosure. The top view 400 shows the photodiode 236 (PD), the TIA 239, the ground plane 373, the first waveguides 282, 284, 286, 288, and 292, and isolation layers 409A-J. FIG. 4 shows that TIA 239 and photodiode 236 are flip-chip bonded to the first submount 241 via the first waveguides 282, 284, 286, 288, and 292. The surface of the TIA 239 shown in FIG. 4 is the bottom surface of TIA 239, or the surface comprising the substrate of the TIA 239. Therefore, FIG. 4 illustrates that the TIA 239 is flip-chip bonded to the first submount 241. Similarly, the surface of the photodiode 236 shown in FIG. 4 is the bottom surface of the photodiode 236, or the surface comprising the substrate of the photodiode 236. Therefore, FIG. 4 illustrates that the photodiode 236 is flip-chip bonded to the first submount 241.

FIG. 4 also shows that the first waveguides 282, 284, 286, 288, and 292 are horizontally separated from the ground plane 373 via isolation layers 409A-J. Isolation layers 409A-J are etched out from the ground plane 373 such that the first waveguides 282, 284, 286, 288, and 292 are surrounded by the first submount 241 and do not contact the ground plane 373. In an embodiment, the isolation layers 409A-J are gaps between each of the first waveguides 282, 284, 286, 288, and 290 and the ground plane 373. In an embodiment, bonding wires may be used to connect the first waveguides 282, 286, 288, and 292 to I/O pins 242, 246, 248, 251, and 254. The first waveguides 282, 284, 286, 288, and 292 are inflexible, relatively flat, integrated on the first submount 241, and have a ground available. In contrast, the bonding wires are flexible, cylindrical, and physically separate from the first submount 241 and do not have a ground available.

The first waveguides 282, 284, 286, 288, and 292 are partially shielded from experiencing EMI from the transmitter of the BOSA because the first waveguides 282, 286, 288, and 292 are coupled to, or bonded onto, the first submount 241 and at least partially surrounded by the ground plane 373. Since the first waveguides 282, 284, 286, 288, and 292 are disposed on the first submount 241 in between sections of the ground plane 373 that have been etched out, the first waveguides 282, 284, 286, 288, and 292 are partially shielded by the ground plane 373. The construction of the first submount 241 with the first waveguides 282, 286, 288, and 292 integrated into the first submount 241 and shielded by the ground layer 373 protects the first waveguides 282, 286, 288, and 292 from experiencing as much EMI as the bonding wires in a traditional BOSA would.

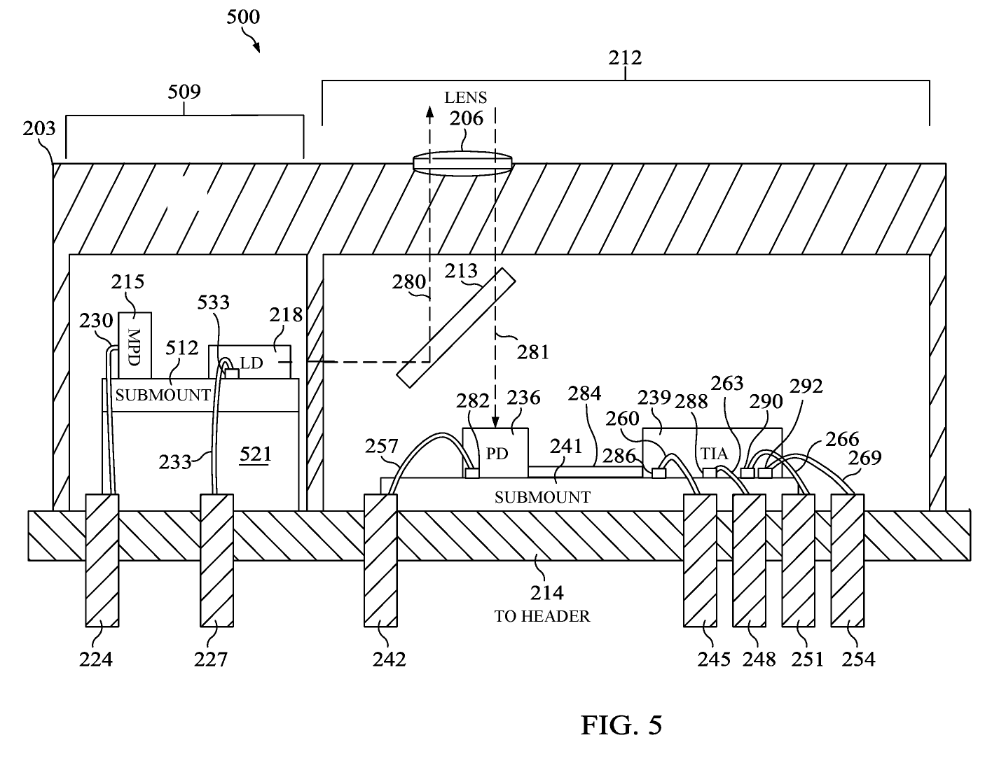

FIG. 5 is a schematic diagram of a portion of a BOSA 500 implemented as an optical transceiver in an ONU 120 or OLT 110 according to another embodiment of the disclosure. The BOSA 500 is similar to the BOSA 200 in FIG. 2 and has similar corresponding components. However, unlike the BOSA 200, the BOSA 500 comprises a second submount 512 for an MPD 215 and a laser diode 218. In addition, the laser diode 218 is flip chip bonded to the second submount 512 via at least one second waveguide 533. In an embodiment where bonding wire 233 is used to connect the at least one second waveguide 533 to an I/O pin 227, the bonding wire 233 may be shorter than the conventional length of the bonding wire that connects the laser diode 218 to the I/O pin 227 used in a BOSA today. The flip chip bonding to the at least one second waveguide 533 and the shorter bonding wires, if necessary, reduce EMI and electromagnetic radiation from the signals communicated between the laser diode 218 and I/O pin 227. The BOSA 500 comprises a TO-cap 203, lens 206, a transmitter 509, a receiver 212, a filter 213, and a TO-header 214. The BOSA 500 may be housed in a single TO-package or TO-can.

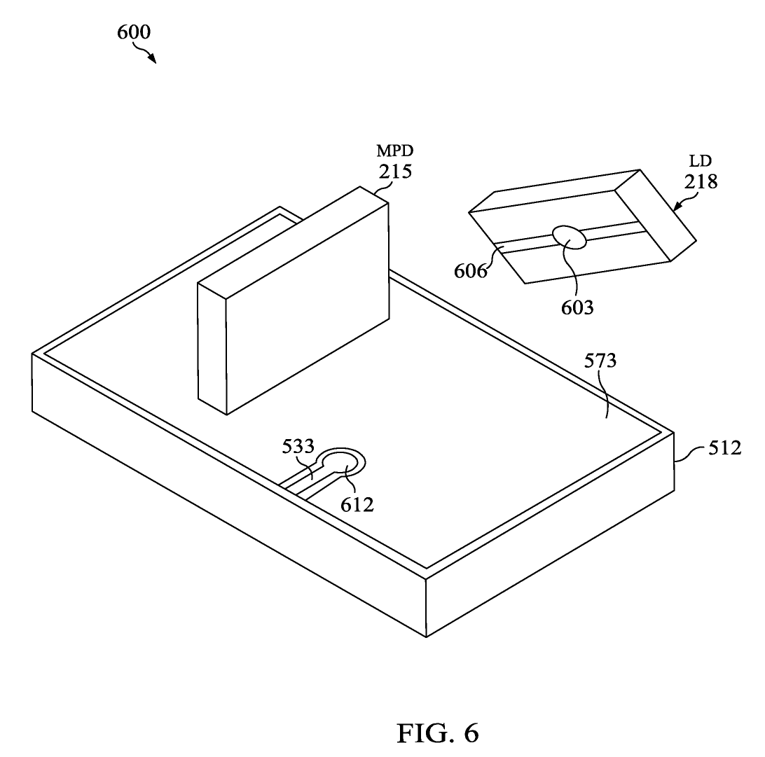

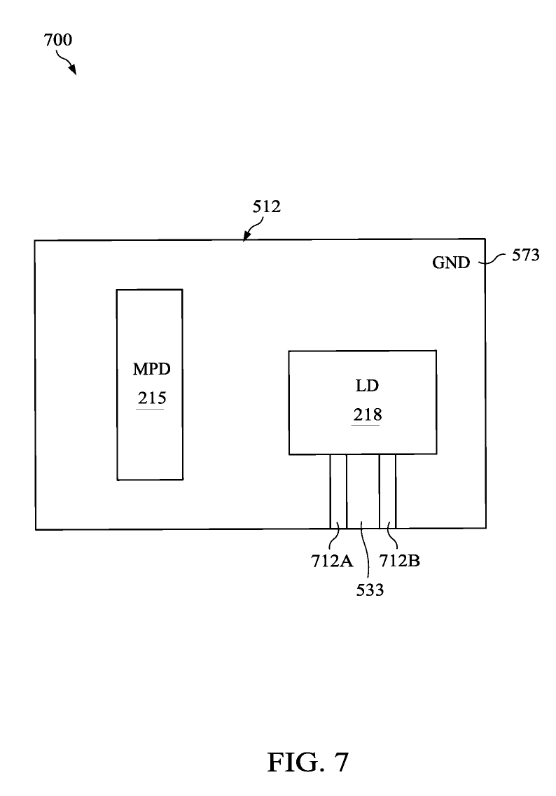

The transmitter 509 comprises the MPD 215 (labeled MPD in FIG. 5), the laser diode 218 (labeled LD in FIG. 5), the metal block 521, a second submount 512, and the I/O pins 224 and 227. As should be appreciated, any number of I/O pins 224 and 227 may be included in the transmitter 509. The laser diode 218 is flip-chip bonded to the second submount 512 via at least one second at least one second waveguide 533. The second submount 512 comprises a dielectric, such as AlN or another suitable material. In an embodiment, second submount 512 comprises at least one second at least one second waveguide 533. For example, at least one second waveguide 533 is deposited onto the second submount 512. In an embodiment, a surface of the second submount 512 comprises a ground plane, and a pattern in the ground plane is etched such that the at least one second waveguide 533 is disposed directly on the second submount 512 and does not contact the ground plane, as is further described below in FIGS. 6-7. The second submount 512 may be positioned on the TO-header 214 or may be positioned on a metal block 521 on the TO-header 214. In an embodiment, second submount 512 comprises a dielectric material, such as aluminum nitride (AlN) or another suitable material.

In an embodiment, the laser diode 218 is flipped upside down so that a contact point on the laser diode 218 is coupled directly to a contact point of the at least one second waveguide 533 on the second submount 512. In an embodiment, at least one second waveguide 533 may couple directly to I/O pin 227. In an embodiment, a bonding wire 233 may be used to couple at least one second waveguide 533 to I/O pin 227. Since the laser diode 218 is flip-chip bonded to the second submount 512, the length of the bonding wire 233 may be much smaller that the bonding wires used in a conventional BOSA that does not implement flip-chip bonding. In an embodiment, the MPD 215 may not be flip chip bonded to the second submount 512, and thus, a waveguide is not needed to connect the bonding wire 230 to the I/O pin 224.

A relatively high modulation current is supplied to the laser diode 218 so that the laser diode 218 may generate an optical signal. In a conventional BOSA, the bonding wire that connected the laser diode 218 to the I/O pin 227 carries the very high modulation current, and thus causes EMI or EMR to occur in the receiver 212. However, flip-chip bonding the laser diode 218 to at least one second waveguide 533 of second submount 512 may reduce the EMI experienced by the receiver 212 because the high current provided to the laser diode 218 travels a much shorter distance in a bonding wire 233.

The receiver 212 comprises a photodiode 236, a TIA 239, a first submount 241, I/O pins 242, 246, 248, 251, and 254, and bonding wires 257, 260, 263, 266, and 269. The first submount 241 comprises first waveguides 282, 284, 286, 288, 290, and 292 that are coplanar with one another in that they all are disposed on the same plane of the first submount 241. In an embodiment, the photodiode 236 and the TIA 239 are flip-chip bonded to the first submount 241 by the first waveguides 282, 284, 286, 288, 290, and 292.

FIG. 6 is a schematic diagram illustrating a portion 600 of the transmitter 509 of BOSA 500 according to an embodiment of the disclosure. The portion 600 of the transmitter 509 comprises the second submount 512, the MPD 215, and the laser diode 218(LD). The second submount 512 comprises a ground plane 573 and a at least one second waveguide 533. In the embodiment shown in FIG. 5, MPD 215 is not flip-chip bonded to second submount 512, and the laser diode 218 is flip-chip bonded to the second submount 512.

The second submount 512 acts as a dielectric layer interposed between the ground plane 573 and the TO-header 214 or the metal block 521 shown in FIG. 5. In an embodiment, the ground plane 573 in the transmitter 509 is similar to the ground plane 373 in the receiver 212. In an embodiment, the ground plane 573 is deposited or laminated onto the second submount 512. The ground plane 573 may be an electrically conductive thin metal layer, such as Au. The ground plane 573 may be a plane that is substantially parallel to the second submount 512. The ground plane 573 is disposed on top of or coupled to the second submount 512 and covers most of the surface of the second submount 512 except for the locations of the second submount 512 where the waveguides and isolation layers are positioned.

In an embodiment, a pattern for at least one second waveguide 533 and an isolation layer surrounding at least one second waveguide 533 may be etched out from the ground plane 573. For example, the ground plane 573 is etched out at the position where at least one second waveguide 533 and the isolation layer surrounding at least one second waveguide 533 is to be positioned. In this way, at least one second waveguide 533 does not contact the ground plane 573 in the vertical direction or the horizontal direction. At least one second waveguide 533 is similar to waveguides 282, 284, 286, 288, 290, and 292. At least one second waveguide 533 may comprise metal, such as Cu, Au, or any other suitable conductive material. At least one second waveguide 533 comprises contact point 612 corresponding to contact point 603 on the laser diode 218. The contact point 612 and contact point 603 may be similar to each other or may have different shapes or sizes to facilitate a connection between contact point 612 and contact point 603.

In an embodiment, the laser diode 218 comprises a bonding pad 606 upon which the contact point 603 is disposed. The contact point 603 on the laser diode 218 faces the contact point 612 of at least one second waveguide 533. In an embodiment, the laser diode 218 is flip-chip bonded to the second submount 512 such that the contact point 603 on the laser diode 218 directly couples, or sits substantially adjacent, to the contact point 612 on at least one second waveguide 533. In an embodiment, a bonding wire 233 may connect the at least one second waveguide 533 to I/O pin 227. The bonding wire 233 and at least one second waveguide 533 may be used to supply a very high modulated current, such as between 30 and 50 mAs, to the laser diode 218 such that the laser diode 218 uses the high modulated current to generate an optical signal.

The laser diode 218 may be bonded to the second submount 512 by soldering or other suitable means. For example, contact point 603 may be soldered together with contact point 612. In an embodiment, contact points 603 and 612 may be solder bumps and/or bonding pads and may comprise Cu, Au, or other suitable material.

The bonding wire 233 that carries the high modulated current may be shorter than traditional bonding wires that are used to connect the laser diode that is not flip-chip bonded to an I/O pin. This is because the laser diode 218 in FIG. 6 is flip-chip bonded to second submount 512 and at least one second waveguide 533 is used in addition to the bonding wire 233 to connect the laser diode 218 to an I/O pin 227. The shorter bonding wire 233 may radiate less EMI or EMR from the transmitter 509. Therefore, the receiver 212 will experience less EMI from the transmitter 509, and crosstalk is effectively reduced in BOSA 500.

FIG. 7 is a top view 700 of the portion 600 of the transmitter 509 of BOSA 500 according to an embodiment of the disclosure. The top view 700 shows the MPD 215, laser diode 218 (LD), ground plane 573, at least one second waveguide 533, and isolation layers 712A-B. FIG. 7 shows that the laser diode 218 is flip-chip bonded to the second submount 512 via at least one second waveguide 533. The surface of the laser diode 218 shown in FIG. 7 is the bottom surface of the laser diode 218, or the surface comprising the substrate of the laser diode 218, thereby illustrating that the laser diode 218 is flip-chip bonded to the second submount 512.

FIG. 7 also shows that at least one second waveguide 533 is horizontally separated from the ground plane 573 via isolation layers 712A and 712B. For example, the ground plane 573 is etched out at the positions where the at least one second waveguide 533 and isolation layers 712A-B are positioned. In an embodiment, isolation layers 712A-B are gaps between the at least one second waveguide 533 and the ground plane 573. In this way, the at least one second waveguide 533 does not touch the ground plane 573 and instead only touches the second submount 512, which is a dielectric layer.

Since the at least one second waveguide 533 is disposed on the second submount 512 in between sections of the ground plane 573 that have been etched out, the at least one second waveguide 533 is partially shielded by the second submount 512 and the ground plane 573. The positioning of the second submount 512 with the at least one second waveguide 533 integrated into the second submount 512 and shielded by the ground layer 573 protects the at least one second waveguide 533 from emitting as much EMI as a bonding wire in a traditional BOSA would.

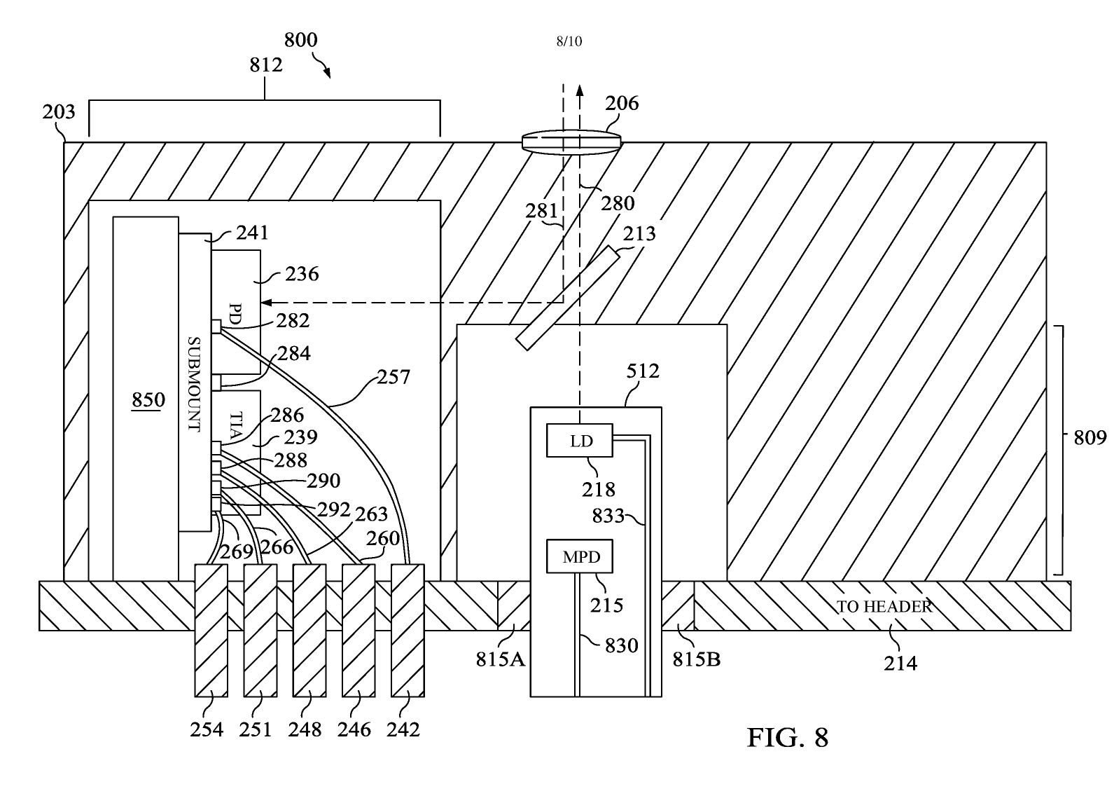

FIG. 8 is a schematic diagram of a portion of a BOSA 800 implemented as an optical transceiver in an ONU 120 or OLT 110 according to yet another embodiment of the disclosure. The BOSA 800 is similar to BOSA 200 in FIG. 2 and has similar corresponding components. However, unlike BOSA 200, BOSA 800 comprises a transmitter 809 integrated into and on the right side of the TO-header 214 such that no bonding wires or I/O pins are needed to connect the laser diode 218 to the PCB. In addition, FIG. 8 shows that the receiver 812 is positioned on the left side of the BOSA 800, and the receiver 812 is rotated horizontally 90 degrees (°) relative to that shown in FIG. 2. The BOSA 800 comprises a TO-cap 203, lens 206, a transmitter 809, a receiver 812, a filter 213, and a TO-header 214. The BOSA 800 may be housed in a single TO-package or TO-can.

As shown in FIG. 8, a portion of the TO-header 214 is removed, or cut out, so that the second submount 512 is positioned in the removed portion of the TO-header 214. Therefore, the second submount 512 sits partially inside the single TO-can BOSA 800 and partially on a PCB external to the single TO-can BOSA 800. The second submount 512 is separated from the TO-header 214 by glass layers 815A and 815B. The glass layers 815A and 815B comprise glass and prevent the metal from the second submount 512 from contacting the metal in the TO-header 214. The glass layers 815A and 815B also seal the TO-header 214 to the second submount 512.

The transmitter 809 comprises an MPD 215, a laser diode 218 (labeled LD in FIG. 8), and the second submount 512. The second submount 512 is a dielectric layer that comprises AlN or another dielectric material. Positions on the second submount 512 where at least one second waveguide 833 and an isolation layer surrounding at least one second waveguide 833 are disposed may be etched out. The at least one second waveguide 833 may be longer than at least one second waveguide 533 in the second submount 512 so that the at least one second waveguide 833 directly contacts a component on a PCB without the use of a bonding wire.

Similar to BOSA 500, the laser diode 218 is flip-chip bonded to the second submount 512 via the at least one second waveguide 833. A contact point on the laser diode 218 may be soldered together with a contact point of the at least one second waveguide 833. In this way, the modulation current that passes through the at least one second waveguide 833 and travels directly to the laser diode 218 without having to travel through a bonding wire 233. The at least one second waveguide 833 may be integrated into second submount 512 so that the at least one second waveguide 833 is partially shielded by a ground plane of the second submount 512, similar to the second submount 512 shown in FIGS. 6 and 7. The at least one second waveguide 833 will emit less EMR than a bonding wire in a traditional BOSA because a bonding wire is not used to connect waveguide 833 to an I/O pin, and the at least one second waveguide 833 is integrated into the second submount 512 where the at least one second waveguide 833 is shielded by a ground plane.

In an embodiment, the MPD 215 is not flip-chip bonded to the second submount 512. Therefore, an electrical wire 830, which may be similar to bonding wire 230, may still be used to connect MPD 215 to the PCB. However, the electrical wire 830 connects directly to the PCB instead of having to connect to an I/O pin. Therefore, in the embodiment shown in FIG. 8, I/O pins are not included in the transmitter 809 since the transmitter is integrated into the TO-header 214.

The receiver 812 is rotated to the right 90° because the transmitter 809 is positioned on the right side of the BOSA 800, and the filter 213 is positioned such that the incoming light received from the filter 213 is provided horizontally to the left. Therefore, the receiver 812 is rotated right 90° so that the photodiode 236 receives the light from the filter 213 at the photosensitive surface of the photodiode 236. Otherwise, the receiver 812 is similar to receiver 212 in that the first submount 241 includes multiple coplanar waveguides with contact points that are configured to connect to contact points on the flip-chip bonded photodiode 236 (labeled PD in FIG. 8) and the TIA 239. Several bonding wires 257, 260, 263, 266, and 269 are used to couple the coplanar waveguides on the first submount 241 with I/O pins 246, 248, 251, 254, and 242. A bonding wire is not needed in between the photodiode 236 and the TIA 239 since waveguide 284 is sufficient to connect the photodiode 236 to the TIA 239.

In the embodiment shown in FIG. 8, the at least one second waveguide 833 emits less electromagnetic radiation because a bonding wire is not used to carry the high current signal to the laser diode 218. In addition, the waveguide 284 may not pick up as much EMI from the transmitter 809 because waveguide 284 is integrated into the first submount 241. Therefore, the embodiment of the BOSA 800 shown in FIG. 8 reduces crosstalk significantly compared to traditional BOSA structures.

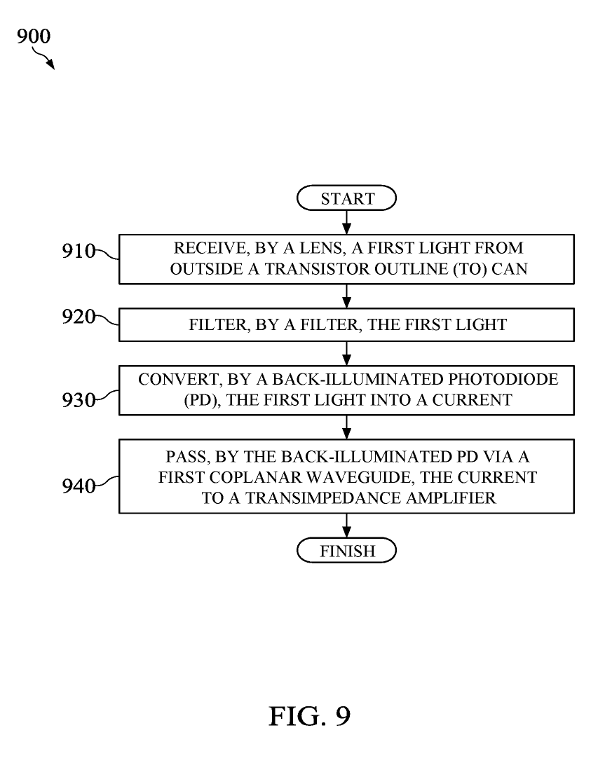

FIG. 9 is a flowchart illustrating a method 900 of receiving light according to an embodiment of the disclosure. The BOSAs 200, 500, 800 may implement the method 900. At step 910, a lens from outside a TO-can receives a first light. For instance, the lens 206 receives the first light. At step 920, a filter filters the first light. For instance, the filter 213 filters the first light. At step 930, a back-illuminated photodiode converts the first light into a current. For instance, the photodiode 236 converts the first light into a current. Finally, at step 940, the photodiode passes the current to a TIA. For instance, the photodiode 236 passes the current to the TIA 239. In an embodiment, the waveguide is positioned on a submount. For example, the waveguide may be deposited onto the submount. In an embodiment, a ground plane may be disposed on the submount and substantially surrounding the waveguide horizontally. In an embodiment, the submount is positioned in between the back-illuminated photodiode and a TO-header of the TO-can. In an embodiment, the method 900 may further include a step of converting the current to a voltage. For example, TIA 239 converts the current to a voltage. In an embodiment, the method 900 may further include a step of communicating the voltage to an I/O pin. For example, the voltage is communicated to an I/O pin via a bonding wire. In an embodiment, the method 900 may further include a step of receiving, via a waveguide, instructions to emit a second light. For example, the laser diode 218 may receive the instructions to emit a second light and emit the second light. In an embodiment, the method 900 may further include a step of filtering the second light. For example, the filter 213 filters the second light. In an embodiment, the method 900 may further include a step of directing the second light outside the TO-can. For example, lens 206 directs the second light outside the TO-can.

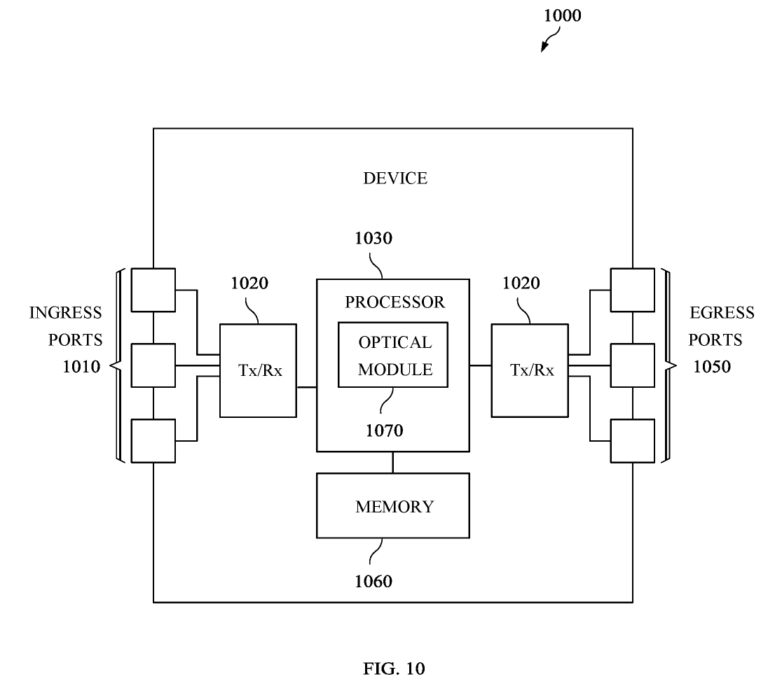

FIG. 10 is a schematic diagram of a device 1000 according to an embodiment of the disclosure. The device 1000 is suitable for implementing the disclosed embodiments described above, including the external device and the external controller on a PCB. The device 1000 comprises ingress ports 1010 transceiver (Tx/Rx) units 1020 for transmitting and receiving data; a processor, logic unit, or central processing unit (CPU) 1030 to process the data; and egress ports 1050 for transmitting the data; and a memory 1060 for storing the data. In an embodiment, the device 1000 is an ONU 120 or an OLT 110. In such an embodiment, Tx/Rx 1020 is an optical transceiver included in an ONU 120 or an OLT 110. The Tx/Rx 1020 may include the one of the BOSAs 200, 500, and 800. The device 1000 may also comprise optical-to-electrical (OE) components and electrical-to-optical (EO) components coupled to the ingress ports 1010, the receiver units 1020, the transmitter units 1040, and the egress ports 1050 for egress or ingress of optical or electrical signals.

The processor 1030 is implemented by any suitable combination of hardware, middleware, firmware, or software. The processor 1030 may be implemented as one or more CPU chips, cores (e.g., as a multi-core processor), field-programmable gate arrays (FPGAs), application specific integrated circuits (ASICs), or digital signal processors (DSPs). The processor 1030 is in communication with the ingress ports 1010, receiver units 1020, transmitter units 1040, egress ports 1050, and/or memory 1060. In an embodiment, the processor 1030 comprises an optical module 1070. In an embodiment, the optical module 1070 may be configured to control the MPD 215, laser diode 218, photodiode 236, or TIA 239. In and embodiment, Tx/Rx 1020 may receive and send data from I/O pins 224, 227, 242, 246, 248, 251, or 254.

The memory 1060 comprises one or more disks, tape drives, or solid-state drives and may be used as an over-flow data storage device, to store programs when such programs are selected for execution, and to store instructions and data that are read during program execution. The memory 1060 may be volatile and/or non-volatile and may be read-only memory (ROM), random-access memory (RAM), ternary content-addressable memory (TCAM), and/or static random-access memory (SRAM).

The use of the term “about” means a range including ±10% of the subsequent number, unless otherwise stated. While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. An optical transceiver comprising:
a transistor outline (TO)-can; and
a receiver housed inside the TO-can, with the receiver comprising:
a first submount comprising at least one first waveguide;
a photodiode coupled to the at least one first waveguide; and
a transimpedance amplifier (TIA) coupled to the first submount and the at least one first waveguide,
wherein the at least one first waveguide couples the photodiode to the TIA, and
wherein the at least one first waveguide is positioned on the first submount in between the photodiode and the TIA.

2. The optical transceiver of claim 1, wherein the photodiode and the TIA are flip-chip bonded to the first submount.

3. The optical transceiver of claim 1, wherein a contact point on the photodiode is coupled to a first contact point on the at least one first waveguide, and wherein a contact point on the TIA is coupled to a second contact point on the at least one first waveguide.

4. The optical transceiver of claim 1, further comprising:
a transmitter housed inside the TO-can, with the transmitter comprising:
a second submount comprising at least one second waveguide;
a bonding wire; and
a laser diode coupled to the at least one second waveguide,
wherein the at least one second waveguide couples the bonding wire to the laser diode.

5. The optical transceiver of claim 4, wherein the laser diode is flip-chip bonded to the second submount.

6. The optical transceiver of claim 5, wherein the TO-can comprises a TO-header and a TO-cap coupled to the TO header, and wherein the second submount passes through the TO-header of the TO-can.

7. The optical transceiver of claim 1, wherein the TO-can comprises:
a TO-header; and
a TO-cap coupled to the TO-header.

8. The optical transceiver of claim 1, wherein the first submount comprises a second waveguide, wherein the second waveguide couples to a bonding wire, and wherein the bonding wire couples to an input/output (I/O) pin of the optical transceiver.

9. The optical transceiver of claim 1, wherein a ground plane is formed on the first submount around the at least one first waveguide and an isolation layer surrounding the at least one first waveguide.

10. The optical transceiver of claim 1, further comprising:
a wavelength-division multiplexing (WDM) filter interposed between the receiver and the transmitter; and
a lens transmitting light between an interior and an exterior of the optical transceiver.

11. An optical transceiver comprising:
a receiver comprising:
a transimpedance amplifier (TIA);
a photodiode; and
a first submount comprising at least one first waveguide, wherein the at least one first waveguide is configured to couple the TIA and the photodiode; and
a transmitter comprising:
a laser diode;
an input/output (I/O) pin; and
a second submount comprising at least one second waveguide, wherein the at least one second waveguide couples to a bonding wire, and wherein the bonding wire couples to the I/O pin.

12. The optical transceiver of claim 11, further comprising a transistor outline (TO)-can housing the transmitter and the receiver.

13. The optical transceiver of claim 11, further comprising a TO-header, wherein the transmitter and the receiver are positioned on the TO-header.

14. The optical transceiver of claim 11, wherein the photodiode and the TIA are flip-chip bonded to the first submount, wherein a contact point on the photodiode is bonded to a first contact point on the at least one first waveguide, and wherein a contact point on the TIA is bonded to a second contact point on the at least one first waveguide.

15. The optical transceiver of claim 11, wherein the laser diode is flip-chip bonded to the second submount, and wherein a contact point on the laser diode is bonded to a contact point on the at least one second waveguide.

16. The optical transceiver of claim 11, wherein a ground plane is formed on the first submount around the at least one first waveguide and an isolation layer surrounding the at least one first waveguide.

17. The optical transceiver of claim 11, wherein a ground plane is formed on the second submount around the at least one second waveguide and an isolation layer surrounding the at least one second waveguide.

18. A method implemented in a transistor outline (TO)-can, the method comprising:
receiving, by a lens, a first light from outside the TO-can;
filtering, by a filter, the first light;
converting, by a back-illuminated photodiode, the first light into a current; and
passing, by the back-illuminated photodiode via a waveguide, the current to a transimpedance amplifier (TIA), wherein the waveguide is positioned on a first submount, and wherein the first submount is positioned in between the back-illuminated photodiode and a TO-header of the TO-can.

19. The method of claim 18, further comprising:
converting, by the TIA, the current to a voltage; and
communicating the voltage to an input/output (I/O) pin via a bonding wire.

20. The method of claim 18, further comprising:
receiving, by a laser diode and via a second waveguide, instructions to emit a second light;
emitting, by the laser diode, the second light;
filtering, by the filter, the second light; and
directing, by the lens, the second light outside the TO-can.
